(19) United States
(12) Patent Application Publication
(10) Pub. No.: US 2015/0134399 A1
(43) Pub. Date: May 14, 2015

(54) INFORMATION MODEL FOR SUPPLY CHAIN RISK DECISION MAKING

(71) Applicant: International Business Machines Corporation, Armonk, NY (US)

(72) Inventors: Hans-Juergen Eickelmann, Nieder-Hilbersheim (DE); Glenn C. Godoy, Endicott, NY (US); Jason D. Horner, Greer, SC (US); Carolyn S. Jackson, Nathrop, CO (US); Gautam Majumdar, Wappingers Falls, NY (US); Karen N. Toger, Wake Forest, NC (US)

(73) Assignee: International Business Machines Corporation, Armonk, NY (US)

(21) Appl. No.: 14/076,773

(22) Filed: Nov. 11, 2013

(51) Int. Cl. G06Q 10/06

(52) U.S. Cl. CPC G06Q 10/0635
USPC 705/7.28

(57) ABSTRACT

An apparatus for building an information model for supply chain risk decision making includes a risk selection module, a priority module, a risk assessment module, and a scheduling module. The risk selection module selects, based upon a profiling questionnaire, one or more risk categories for an assessment subject. The priority module sets, based upon the profiling questionnaire, a level of importance of and a risk tolerance for the assessment subject in a supply chain. The risk assessment module receives, for each risk category of the one or more risk categories for the assessment subject, a likelihood and an impact of the risk category. The scheduling module sets a risk assessment schedule of the assessment subject based upon the level of importance of the assessment subject.

### FIELD

The subject matter disclosed herein relates to risk assessment and more particularly relates to modeling risk for supply chain risk decision making.

### BACKGROUND

A healthy and robust supply chain is important to many businesses and industries. Proper supply chain management takes into account potential events or conditions that may adversely affect a supply chain. Businesses may have multiple supply chains, and these supply chains may or may not share common elements. Identifying critical supply chain elements and the potential risks to these elements allow businesses to prepare contingency plans in case of adverse events or conditions. Businesses have limited resources, so identifying the most likely and/or most impactful risks to a supply chain will lead businesses to plan properly for these risks. In addition, since the likelihood of and the impact of various risks differ, it is more efficient and rational to review risks that are more likely and/or have a higher impact more often compared to risks that are not as likely or would have a limited impact on the supply chain.

### BRIEF SUMMARY

An apparatus for building an information model for supply chain risk decision making is disclosed. The apparatus includes a risk selection module, a priority module, a risk assessment module, and a scheduling module. The risk selection module, in one embodiment, selects, based upon a profiling questionnaire, one or more risk categories for an assessment subject. The priority module, in one embodiment, sets, based upon the profiling questionnaire, a level of importance of and a risk tolerance for the assessment subject in a supply chain.

In one embodiment, the priority module sets, based on one or more other profiling questionnaires, the level of importance of and the risk tolerance for the assessment subject. In another embodiment, the priority module sets a level of importance of and a risk tolerance for an assessment bundle. The assessment bundle includes several risk categories of the one or more risk categories for the assessment subject. The risk assessment module, in one embodiment, receives, for each risk category of the one or more risk categories for the assessment subject, a likelihood and an impact of the risk category. The scheduling module, in one embodiment, sets a risk assessment schedule of the assessment subject based upon the level of importance of the assessment subject.

In one embodiment, the risk assessment schedule of the assessment subject includes a risk assessment schedule for each risk category of the one or more risk categories for the assessment subject. The risk assessment schedule for each risk category of the one or more risk categories for the assessment subject includes a number of risk assessments over a set period of time. The number of risk assessments for each risk category depends upon the likelihood and impact of the risk category. In another embodiment, the risk assessment of the assessment subject includes a risk assessment schedule of an assessment bundle based upon the level of importance of the assessment bundle.

In one embodiment, the apparatus also includes a risk rating module that aggregates a most recently completed risk assessment for each risk category of the one or more risk categories for the assessment subject to form a composite risk rating of the assessment subject. In another embodiment, the apparatus includes an alert module that flags the assessment subject for urgent risk assessment in response to identifying a crisis that may affect the assessment subject.

A method for building an information model for supply chain risk decision making is disclosed. The method includes, in one embodiment, selecting, based upon a profiling questionnaire, one or more risk categories for an assessment subject, and setting, based upon the profiling questionnaire, a level of importance of and a risk tolerance for the assessment subject in a supply chain. The method includes receiving, for each risk category of the one or more risk categories for the assessment subject, a likelihood and an impact of the risk category, and setting a risk assessment schedule of the assessment subject based upon the level of importance of the assessment subject.

In one embodiment, the method also includes flagging the assessment subject for urgent risk assessment in response to identifying a crisis that may affect the assessment subject. In another embodiment, the method includes setting, based upon one or more other profiling questionnaires, the level of importance of and the risk tolerance for the assessment subject in the supply chain. In a certain embodiment of the method, the risk assessment schedule of the assessment subject includes a risk assessment schedule for each risk category of the one or more risk categories for the assessment subject.

In some embodiments of the method, the risk assessment schedule for each risk category of the one or more risk categories for the assessment subject includes a number of risk assessments over a set period of time, the number of risk assessments for each risk category dependent upon the likelihood and an impact of the risk category.

In a particular embodiment, the method includes aggregating a most recently completed risk assessment for each risk category of the one or more risk categories for the assessment subject to form a composite risk rating of the assessment subject. In one embodiment, the method includes setting a level of importance of and a risk tolerance for an assessment bundle. The assessment bundle includes several risk categories of the one or more risk categories for the assessment subject, and the risk assessment schedule of the assessment subject includes a risk assessment schedule of the assessment bundle based upon the level of importance of the assessment bundle.

A computer program product for building an information model for supply chain risk decision making is disclosed. The computer program product includes, in one embodiment, a computer readable storage medium having program code embodied therein. The program code is readable/executable by a processor for selecting, based upon a profiling questionnaire, one or more risk categories for an assessment subject and setting, based upon the profiling questionnaire, a level of importance of and a risk tolerance for the assessment subject in a supply chain. The computer program product includes, in one embodiment, receiving, for each risk category of the one or more risk categories for the assessment subject, a likelihood and an impact of the risk category and setting a risk assessment schedule of the assessment subject based upon the level of importance of the assessment subject.

In one embodiment, the computer program product further sets, based upon one or more other profiling questionnaires, the level of importance of and the risk tolerance for the assessment subject of the supply chain. In another embodiment, the risk assessment schedule of the assessment subject includes a risk assessment schedule for each risk category of the one or more risk categories for the assessment subject. In a certain embodiment, the risk assessment schedule for each risk category of the one or more risk categories for the assessment subject includes a number of risk assessments over a set period of time. The number of risk assessments for each risk category is dependent upon the likelihood and an impact of the risk category.

In some embodiments, the computer program also aggregates a most recently completed risk assessment for each risk category of the one or more risk categories for the assessment subject to form a composite risk rating of the assessment subject. In an embodiment, the computer program also sets a level of importance of and a risk tolerance for an assessment bundle, the assessment bundle comprising a plurality of risk categories of the one or more risk categories for the assessment subject, and the risk assessment schedule of the assessment subject includes a risk assessment schedule of the assessment bundle based upon the level of importance of the assessment bundle.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for building an information model for supply chain risk decision making;

FIG. 2 is a schematic block diagram illustrating one embodiment of an apparatus for building an information model for supply chain risk decision making;

FIG. 3 is a schematic block diagram illustrating another embodiment of an apparatus for building an information model for supply chain risk decision making;

FIG. 4 is a schematic flow chart diagram illustrating one embodiment of a method for building an information model for supply chain risk decision making; and

FIG. 5 is a schematic flow chart diagram illustrating another embodiment of a method for building an information model for supply chain risk decision making;

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The description of elements in each figure may refer to elements of proceeding figures. Like numbers refer to like elements in all figures, including alternate embodiments of like elements.

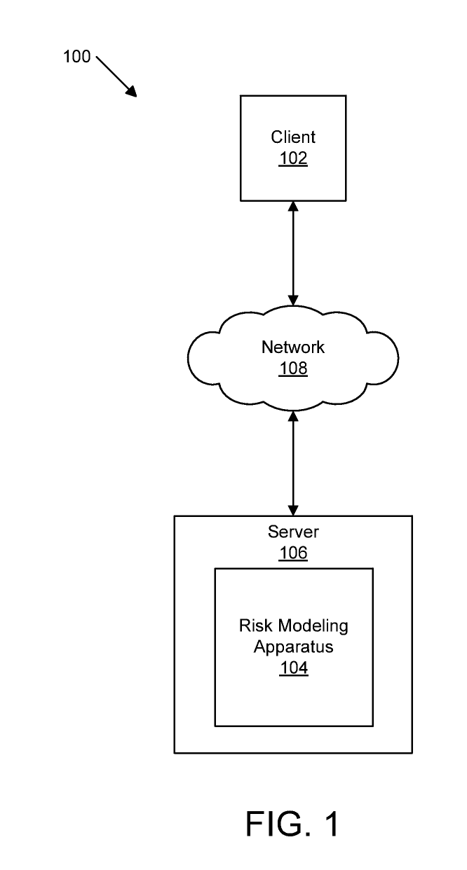

FIG. 1 is a schematic block diagram illustrating one embodiment of a system for building an information model for supply chain risk decision making. The system 100 includes a client 102 connected to a risk modeling apparatus 104 on a server 106 through a network 108, which are described below.

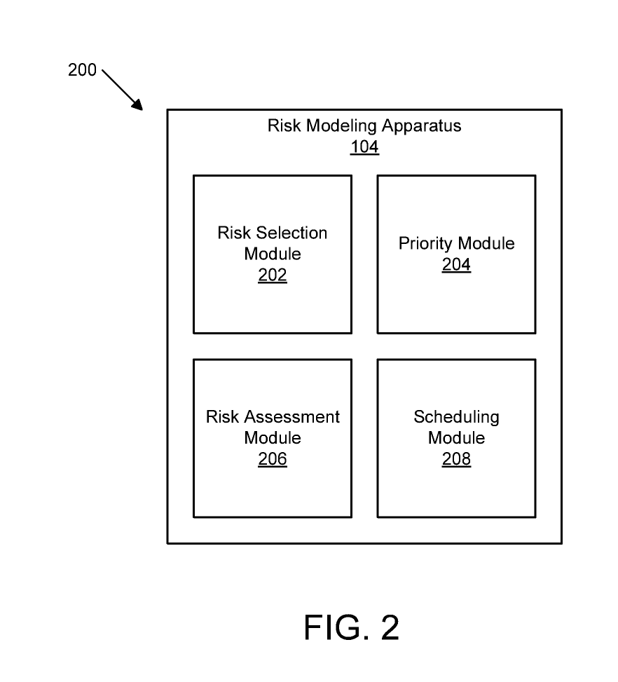

In one embodiment, the system includes a risk modeling apparatus 104 on a server 106. The risk modeling apparatus 104 receives profiling questionnaire answers from a client 102 over a network 108. The risk modeling apparatus 104 is described in more detail with respect to the apparatus 200 in FIG. 2. The client 102 may be any device capable of sending profiling questionnaire answers to a server 106 over a network 108. For example, the client 102 may be a laptop or desktop computer. In another example, the client 102 may be a tablet. In further example, the client 102 may be a smartphone. The client 102 could also be another server. The network 108 may include a local area network (“LAN”), a wide area network (“WAN”), wireless network, cellular network, the internet, or the like. The network 108 may include a combination of computer networks. The network 108 includes cabling, routers, switches and other computer networking equipment. In one embodiment, the risk modeling apparatus 104 may be accessed directly from a user interface to the server 106.

FIG. 2 is a schematic block diagram illustrating one embodiment of an apparatus 200 for risk assessment of supply chain elements. The apparatus 200 includes one embodiment of a risk modeling apparatus 104 with a risk selection module 202, a priority module 204, a risk assessment module 206, and a scheduling module 208, which are described below.

The risk selection module 202 selects, based upon a profiling questionnaire, one or more risk categories for an assessment subject. An assessment subject is an element in a supply chain. For example, an assessment subject may be a supplier in a supply chain. As another example, an assessment subject may be the geographical location of the supplier. An assessment subject, in one embodiment, may be a product comprised of multiple components produced by a supplier. The product may be represented by a part number.

A risk category denotes a type of event or condition that adversely affects an assessment subject, and the risk categories for an assessment subject may differ from the risk categories for another assessment subject. The risk selection module 202 selects the risk categories for the assessment subject based upon profiling questionnaire responses from users or groups who rely on the assessment subject. The profiling questionnaire, in one embodiment, is designed to ascertain possible risk categories for an assessment subject. In some embodiments, the profiling questionnaire contains varying standardized questions depending on the industry of the user or group responding to the questionnaire. For example, with respect to the defense and weapons industry, the profiling questionnaire may contain standard questions relating to risk categories such as labor availability and information security (e.g., Does subcontractor S have enough skilled engineers? How secure is supplier X's information systems? Does subcontractor U encrypt its data?). As another example, with respect to the food industry, the profiling questionnaire may contain standard questions relating to risk categories such as environment and government regulation (e.g., Does the concentration of chemicals in crops or animals supplied by company C to make product P exceed the level considered safe for consumption? Is there adequate government oversight of farms and/or factory conditions?).

The risk selection module 202, in one embodiment, selects questions contained in the profiling questionnaire and presents a plurality of possible responses. Based upon responses selected by a respondent to questions of the profiling questionnaire, the risk selection module 202 selects applicable risk categories for the assessment subject. In certain embodiments, the risk selection module 202 selects a risk category based upon a response to a single question. In particular embodiments, the risk selection module 202 selects a risk category based upon responses to several questions. The risk selection module 202 presents advantages over allowing users or groups relying on an assessment subject to manually decide which risk categories may apply to the assessment subject. By choosing the risk categories that apply to an assessment subject based upon answers to a profiling questionnaire, the risk selection module 202 eliminates the presence of bias or a lack of information inherent in user or groups who rely on the assessment subject. In addition, the risk selection module 202 and its automatic assignment of risk categories for assessment subjects eliminates the potential for human error or inconsistency.

The priority module 204, in one embodiment, sets a level of importance of and a risk tolerance for an assessment subject based upon responses to a profiling questionnaire given by a user or group who relies on the assessment subject. The level of importance of an assessment subject reflects the magnitude of disruption that a failure or shortage relating to the assessment subject may have on the supply chain. The priority module 204 may express the level of importance of the assessment subject in a variety of ways. In one form, the priority module 204 presents the level of importance as a numerical value (e.g., 1, 2, 3 . . . 100). In another form, the priority module 204 presents the level of importance as a color (e.g., red, yellow, green). Alternatively, the priority module 204 presents the level of importance as text (e.g., very high, high, somewhat high, neutral, somewhat low, low, very low). The risk tolerance for an assessment subject reflects a sensitivity of the user or group relying on the assessment subject to a failure or shortage relating to the assessment subject. Risk tolerance may be expressed in different forms like the level of importance. Risk tolerance and level of importance for assessment subjects are inversely related (i.e., high level of importance denotes low risk tolerance and vice versa).

The profiling questionnaire, in one embodiment, is designed to ascertain a level of importance of and a risk tolerance for an assessment subject to a user or group relying on the assessment subject. For example, the profiling questionnaire may contain questions regarding the fungibility of the assessment subject (e.g., Besides supplier A, how many other suppliers can provide the same component within the required time at the same or lower price? Besides supplier B, how many other suppliers have the expertise to produce component C?) As another example, the profiling questionnaire may contain questions regarding the availability of the assessment subject (e.g., How abundant/scarce is component X? Is component Y the limiting factor in the production of this product?). The priority module 204, in one embodiment, selects questions contained in the profiling questionnaire and presents a plurality of possible responses. Based upon responses selected by a respondent to questions of the profiling questionnaire, the risk selection module 202 sets the level of importance of and risk tolerance for the assessment subject.

In one instance, the questions of the profiling questionnaire are weighted such that responses to certain questions have more influence on the level of importance of and the risk tolerance for the assessment subject than responses to other questions. In another instance, the answers to the questions of the profiling questionnaire are weighted in the calculation of the level of importance and the risk tolerance for the assessment subject. The weighted value of the questions and/or answers to the profiling questionnaire, in one embodiment, is used to calculate the level of importance and/or risk tolerance for an assessment subject. For example, the level of importance and/or risk tolerance may be based upon an average of the weighted values of the questions and/or answers to the profiling questionnaire. In another example, the level of importance and/or risk tolerance may be based upon a median of the weighted values. In yet another example, the level of importance and/or risk tolerance may be based upon the highest weighted value.

The priority module 204 presents advantages over allowing users or groups relying on an assessment subject to manually decide the level of importance or risk tolerance to the assessment subject. By using the priority module 204 to objectively set a level of importance of and a risk tolerance for an assessment subject based upon answers to a profiling questionnaire, the risk selection module 202 eliminates the presence of bias or a lack of information inherent in user or groups who rely on the assessment subject. In addition, the risk selection module 202 and its automatic assignment of risk categories for assessment subjects eliminates the potential for human error or inconsistency.

In another embodiment, the priority module 204 sets the level of importance of and the risk tolerance for the assessment subject based upon responses to one or more other profiling questionnaires given by users who rely on the assessment subject. In this embodiment, the priority module 204 sets the level of importance of the assessment subject to the highest level of importance reflected in the responses to the profiling questionnaires given by users or groups who rely on the assessment subject. For example, a supplier may provide two commodities to a company, with each commodity being used by a different team within the company.

One commodity may be common and easily sourced from a different supplier, and thus the team using the common commodity may respond to the profiling questionnaire in a way that causes the priority module 204 to set a low level of importance for the supplier. But the other commodity may be very rare with only one alternate supplier, and thus the team using the rare commodity may respond to the profiling questionnaire in a way that causes the priority module 204 to set a high level of importance for the supplier. The priority module 204, under these circumstances, sets the level of importance of the supplier to a high level of importance. Similarly, given responses to one or more other profiling questionnaires, the priority module 204 sets the risk tolerance of the assessment subject to the lowest risk tolerance reflected in the profiling questionnaire responses. Setting the level of importance and risk tolerance of the assessment subject in this manner ensures that an assessment subject will be assessed in a timely manner in relation to its risk categories, as discussed further below.

The priority module 204, in certain embodiments, sets a level of importance of and a risk tolerance for an assessment bundle pertaining to an assessment subject. An assessment bundle includes two or more risk categories that are assessed concurrently. The risk categories forming an assessment bundle may be assessed concurrently for various reasons. In one instance, risk categories are assessed concurrently because the assessment is performed by the same individual or group. In another instance, risk categories are assessed concurrently because their assessment depends on the same source of information. Risk categories may also be assessed concurrently because they have the same rate of variability (i.e., the risk level of the risk categories change at the same rate).

The level of importance of an assessment bundle reflects the magnitude of disruption that an adverse event or condition represented by the risk categories may have on the assessment subject and/or the supply chain. The level of importance of the assessment bundle may be expressed in a variety of ways. In one form, the level of importance may be a numerical value (e.g., 1, 2, 3 . . . 100). In another form, the level of importance may be expressed as a color (e.g., red, yellow, green). Alternatively, the level of importance may be expressed as text (e.g., very high, high, somewhat high, neutral, somewhat low, low, very low). The risk tolerance for an assessment bundle reflects a sensitivity of a user or group to an adverse event or condition represented by the risk categories. Risk tolerance may be expressed in different forms like the level of importance. Risk tolerance and level of importance for assessment bundles are inversely related (i.e., high level of importance denotes low risk tolerance and vice versa).

The risk assessment module 206 receives, for each risk category of the one or more risk categories for the assessment subject, a likelihood of and an impact of the risk category. An assessment of a risk category includes a likelihood of and an impact of the risk category. In one embodiment, the risk assessment module 206 receives the likelihood of and an impact of the risk category from the client 102. The likelihood of a risk category (a particular type of an adverse event or condition) may be expressed in various forms. In one form, the likelihood of an adverse event or condition may be a numerical value (e.g., 0.15, 15%, 15 on a scale of 1-100). In another form, the likelihood of an adverse event or condition may be expressed as text (e.g., very unlikely, unlikely, not expected, possible, likely, very likely). The impact of a risk category to a supply chain may be expressed in similar ways. For example, the impact of a risk category may be expressed in numbers (e.g., 1, 2, 3 . . . 10). The impact of a risk category can also be expressed as text (e.g., no impact, very low impact, low impact, medium impact, high impact, very high impact). The risk assessment module 206, in certain embodiments, stores the likelihood and impact of the risk category for later retrieval.

The scheduling module 208 sets a risk assessment schedule of the assessment subject based upon the level of importance of the assessment subject. A risk assessment schedule includes a number of risk assessments over a set period of time (i.e., risk assessment frequency). The risk assessment frequency for an assessment subject is related to the level of importance of the assessment subject. An assessment subject with a higher level of importance will have more risk assessments over the same period of time (i.e., higher risk assessment frequency) as an assessment subject with a lower level of importance. In one embodiment, the scheduling module 208 sets the risk assessment schedule of the assessment subject such that the one or more risk categories for the assessment subject are assessed at the same time. In another embodiment, the scheduling module 208 sets the risk assessment schedule of the assessment subject such that at least two risk categories for the assessment subject are assessed at different times.

In certain embodiments, the risk assessment schedule of the assessment subject includes a risk assessment schedule for each risk category of the one or more risk categories for the assessment subject. In these embodiments, the risk assessment schedule of a risk category is based upon the likelihood of and the impact of the risk category. A higher likelihood of an adverse event or condition represented by the risk category and/or a higher impact of the risk category will lead to a higher risk assessment frequency for the risk category (i.e., more risk assessments over a set period of time). Conversely, a lower likelihood of an adverse event or condition represented by the risk category and/or a lower impact of the risk category will lead to a lower risk assessment frequency for the risk category. Giving each risk category its own risk assessment schedule provides more flexibility and is a more efficient use of resources because a person or group will only need to perform an assessment of a risk category when necessary. In some embodiments, the risk assessment schedule of the assessment subject includes a risk assessment schedule of an assessment bundle based upon the level of importance of the assessment bundle.

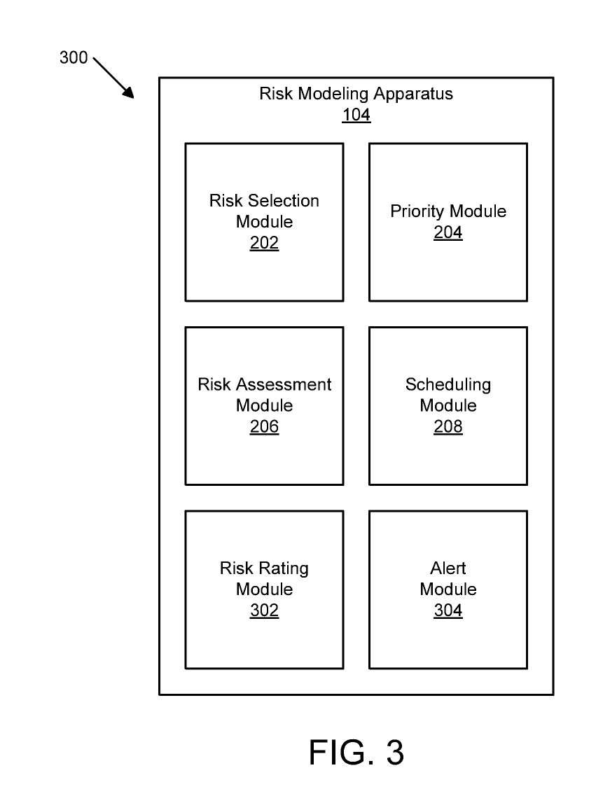

FIG. 3 is a schematic block diagram illustrating another embodiment of an apparatus 300 for risk assessment of supply chain elements. The apparatus 300 includes another embodiment of a risk modeling apparatus 104 with a risk selection module 202, a priority module 204, a risk assessment module 206, and a scheduling module 208, which are substantially similar to those described above in relation to apparatus 200 in FIG. 2. The apparatus 300 also includes a risk rating module 302 and an alert module 304, which are described below.

The risk rating module 302, in one embodiment, aggregates a most recently completed assessment for each risk category of the one or more categories for the assessment subject in order to form a composite risk rating of the assessment subject. The composite risk rating of the assessment subject, in one embodiment, includes the most recently completed assessments of the risk categories for the assessment subject. In one example, the most recently completed assessments of the risk categories include the risk assessments of assessment bundles. In some embodiments, the risk category assessments forming the composite risk rating of the assessment subject may have been completed at the same time. In other embodiments, some of the risk category assessments forming the composite risk rating of the assessment subject were completed at the same time, while other risk category assessments were completed at different times. In still other embodiments, the risk category assessments forming the composite risk rating of the assessment subject were completed at different times. The risk rating module 302, in certain embodiments, aggregates the most recently completed assessment for each risk category of the assessment subject according to a preset schedule. In certain embodiments, the risk rating module 302 aggregates the most recently completed assessment for each risk category of the assessment subject upon the completion of an assessment of a risk category of the assessment subject.

The alert module 304, in one embodiment, flags an assessment subject for urgent risk assessment in response to identifying a crisis that may affect the assessment subject. In another embodiment, the alert module 304 sets an indicator for the assessment subject that informs an individual or group that an urgent risk assessment of the assessment subject is needed. This indicator may override the normal risk assessment schedule for the assessment subject. A crisis is typically an event or condition that has a sudden adverse impact on an assessment subject. The crisis can encompass natural or manmade disasters (e.g., earthquake, hurricane, tornado, chemical spill), geopolitical events (e.g., military coup), financial issues (e.g., bankruptcy), and other types of emergencies. The scope of a crisis may be physical or far reaching (e.g., nuclear plant meltdown, financial crisis). In certain embodiments, the alert module 304 identifies a crisis that may affect an assessment subject by determining that the assessment subject is within a crisis affected area. In other embodiments, the alert module 304 identifies a crisis that may affect an assessment subject by determining that the assessment subject is within a geographical area affected by the crisis (e.g., a supplier is located within the radius of radiation fallout from a nuclear reactor meltdown). In yet other embodiments, the alert module 304 identifies a crisis that may affect an assessment subject by determining that the type of the crisis matches a risk category of the assessment subject.

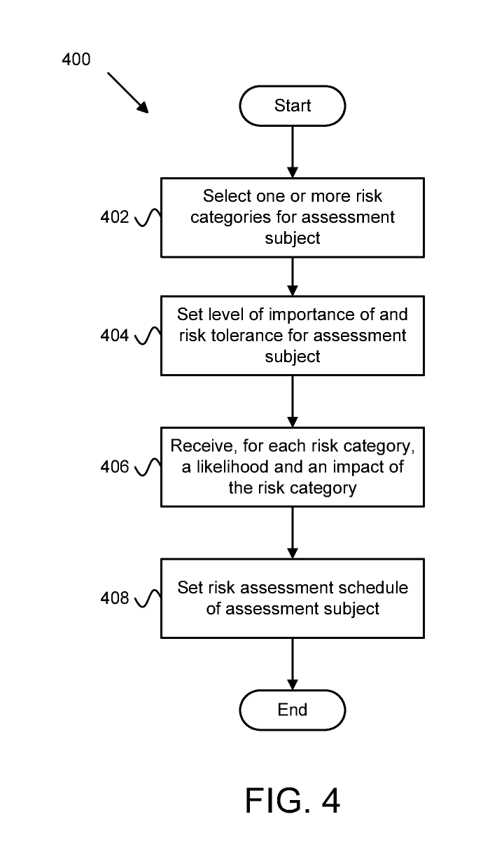

FIG. 4 is a schematic flow chart diagram illustrating one embodiment of a method 400 for building an information model for supply chain risk decision making. The method 400 begins and selects 402, based upon a profiling questionnaire, one or more risk categories for an assessment subject. The method 400 sets 404, based upon the profiling questionnaire, a level of importance of and risk tolerance for the assessment subject. In another embodiment, the method 400 sets 404 the level of importance of and risk tolerance for the assessment subject based upon one or more other profiling questionnaires. The method 400, in one embodiment, receives 406, for reach risk category of the one or more risk categories for the assessment subject, a likelihood and an impact of the risk category. The method 400 sets 408, in one embodiment, a risk assessment schedule of the assessment subject based upon the level of importance of the assessment subject, and the method 400 ends.

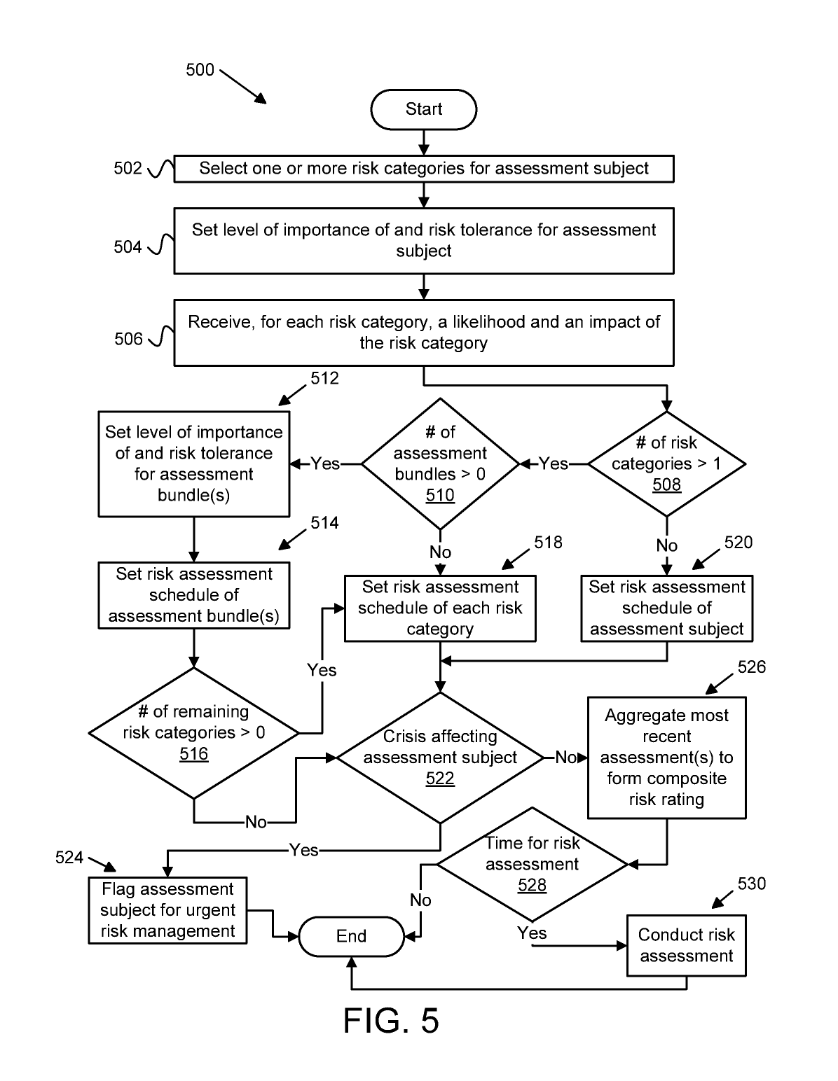

FIG. 5 is a schematic flow chart diagram illustrating another embodiment of a method for building an information model for supply chain risk decision making. The method 500 begins and selects 502, based upon a profiling questionnaire, one or more risk categories for an assessment subject. The method 500 sets 504, based upon the profiling questionnaire, a level of importance of and risk tolerance for the assessment subject. In an alternate embodiment, the method 500 sets 504 the level of importance of and risk tolerance for the assessment subject based upon one or more other profiling questionnaires. The method 500 receives 506, for reach risk category of the one or more risk categories for the assessment subject, a likelihood and an impact of the risk category.

The method 500 determines 508 whether there is more than one risk category selected for the assessment subject. If there is only one risk category selected for the assessment subject, the method 500 sets 520 a risk assessment schedule of the assessment subject. Under this scenario, the risk assessment schedule of the assessment subject includes a risk assessment schedule of the risk category selected for the assessment subject. The risk assessment schedule of a risk category includes a number of risk assessments over a set period of time. The number of risk assessments is based upon the likelihood and impact of the risk category. If there are multiple risk categories selected for the assessment subject, the method 500 determines 510 whether the number of assessment bundles (i.e., risk categories that may be evaluated concurrently) is greater than zero. If there are no assessment bundles, the method 500 sets 518 a risk assessment schedule of the assessment subject. Under this scenario, the risk assessment schedule of the assessment subject includes a risk assessment schedule for each risk category of the one or more risk categories for the assessment subject. The risk assessment schedule for each risk category includes a number of risk assessments over a set period of time. The number of risk assessments is based upon the likelihood and impact of the risk category.

If there is at least one assessment bundle, the method 500 sets 512 the level of importance and risk tolerance for each assessment bundle. The assessment bundle includes several risk categories for the assessment subject. The method 500 sets 514 a risk assessment schedule of each assessment bundle. The risk assessment schedule for each assessment bundle includes a number of risk assessments over a set period of time, with the number of risk assessments based upon the level of importance of the assessment bundle. After the method 500 sets 514 a risk assessment schedule of the assessment bundle(s), the method 500 determines 516 whether there are any remaining risk categories for the assessment subject. For any remaining risk categories, the method 500 sets 518 a risk assessment schedule of each risk category. The risk assessment schedule of each remaining risk category includes a number of risk assessments over a set period of time. The number of risk assessments is based upon the likelihood and impact of the risk category.

The method 500 determines 522 whether there is a crisis that may affect the assessment subject. If the method 500 determines 522 that there is a crisis that may affect the assessment subject, the method 500 flags 524 the assessment subject for urgent risk management. In one embodiment, the method 500 flags 524 an assessment subject for urgent risk management by setting an emergency indicator of the assessment subject. The emergency indicator may contain other information, such as identification for a crisis to distinguish between different crises. In some embodiments, the emergency indicator may contain multiple crisis identifications so that it may indicate multiple crises affecting an assessment subject. Setting an emergency indicator for assessment subjects allows individuals or groups to readily see which assessment subjects need immediate attention. For example, a list of suppliers affected by a crisis may be generated filtering for all assessment subjects that have a particular emergency indicator. In one embodiment, after the method 500 flags 524 an assessment subject for urgent risk management, the method 500 ends.

If the method 500 determines 522 that there is no crisis that may affect the assessment subject, the method 500 aggregates 526 the most recently completed risk assessments for each risk category of the one or more risk categories for the assessment subject to form a composite risk rating of the assessment subject. In one embodiment, the most recently completed risk assessments for each risk category are completed at the same time. In another embodiment, the most recently completed risk assessments for each risk category are completed at different times. In some embodiments, some of the most recently completed risk assessments for each category are completed at the same time and some of the most recently completed risk assessments for each category are completed at different times.

The method 500 determines 528 whether a scheduled time for assessment of a risk category of the one or more risk categories has arrived. If the method 500 determines 528 that a scheduled time for assessment of a risk category has not arrived, the method 500 ends. If the method 500 determines 528 that a scheduled time for assessment of a risk category has arrived, the method 500 conducts 530 the scheduled risk assessment and the method 500 ends. In one embodiment, after the method 500 conducts 530 the scheduled risk assessment, the method 500 aggregates 526 the most recently completed risk assessments for each risk category of the one or more risk categories for the assessment subject to form a composite risk rating of the assessment subject, and the method 500 ends.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a risk selection module that selects, based upon a profiling questionnaire, one or more risk categories for an assessment subject;
a priority module that sets, based upon the profiling questionnaire, a level of importance of and a risk tolerance for the assessment subject in a supply chain;
a risk assessment module that receives, for each risk category of the one or more risk categories for the assessment subject, a likelihood and an impact of the risk category; and
a scheduling module that sets a risk assessment schedule of the assessment subject based upon the level of importance of the assessment subject;
wherein at least a portion of the priority module, the risk selection module, the risk assessment module, and the scheduling module comprise one or more of hardware and executable code, the executable code stored on one or more computer readable storage media.

2. The apparatus of claim 1, further comprising an alert module that flags the assessment subject for urgent risk assessment in response to identifying a crisis that may affect the assessment subject.

3. The apparatus of claim 1, wherein the priority module sets, based upon one or more other profiling questionnaires, the level of importance of and the risk tolerance for the assessment subject in the supply chain.

4. The apparatus of claim 1, wherein the risk assessment schedule of the assessment subject comprises a risk assessment schedule for each risk category of the one or more risk categories for the assessment subject.

5. The apparatus of claim 4, wherein the risk assessment schedule for each risk category of the one or more risk categories for the assessment subject comprises a number of risk assessments over a set period of time, the number of risk assessments for each risk category dependent upon the likelihood and impact of the risk category.

6. The apparatus of claim 5, further comprising a risk rating module that aggregates a most recently completed risk assessment for each risk category of the one or more risk categories for the assessment subject to form a composite risk rating of the assessment subject.

7. The apparatus of claim 1, wherein:
the priority module further sets a level of importance of and a risk tolerance for an assessment bundle, the assessment bundle comprising a plurality of risk categories of the one or more risk categories for the assessment subject; and
wherein the risk assessment schedule of the assessment subject comprises a risk assessment schedule of the assessment bundle based upon the level of importance of the assessment bundle.

8. A method of building an information model for supply chain risk decision making comprising:
selecting, based upon a profiling questionnaire, one or more risk categories for an assessment subject;
setting, based upon the profiling questionnaire, a level of importance of and a risk tolerance for the assessment subject in a supply chain;
receiving, for each risk category of the one or more risk categories for the assessment subject, a likelihood and an impact of the risk category; and
setting a risk assessment schedule of the assessment subject based upon the level of importance of the assessment subject.

9. The method of claim 8, further comprising flagging the assessment subject for urgent risk assessment in response to identifying a crisis that may affect the assessment subject.

10. The method of claim 8, wherein the method further comprises setting, based upon one or more other profiling questionnaires, the level of importance of and the risk tolerance for the assessment subject in the supply chain.

11. The method of claim 8, wherein the risk assessment schedule of the assessment subject comprises a risk assessment schedule for each risk category of the one or more risk categories for the assessment subject.

12. The method of claim 11, wherein the risk assessment schedule for each risk category of the one or more risk categories for the assessment subject comprises a number of risk assessments over a set period of time, the number of risk assessments for each risk category dependent upon the likelihood and impact of the risk category.

13. The method of claim 12, wherein the method further comprises aggregating a most recently completed risk assessment for each risk category of the one or more risk categories for the assessment subject to form a composite risk rating of the assessment subject.

14. The method of claim 8, wherein the method further comprises
setting a level of importance of and a risk tolerance for an assessment bundle, the assessment bundle comprising a plurality of risk categories of the one or more risk categories for the assessment subject; and
wherein the risk assessment schedule of the assessment subject comprises a risk assessment schedule of the assessment bundle based upon the level of importance of the assessment bundle.

15. A computer program product for building an information model for supply chain risk decision making, the computer program product comprising a computer readable storage medium having program code embodied therein, the program code readable/executable by a processor for:
selecting, based upon a profiling questionnaire, one or more risk categories for an assessment subject;
setting, based upon the profiling questionnaire, a level of importance of and a risk tolerance for the assessment subject in a supply chain;
receiving, for each risk category of the one or more risk categories for the assessment subject, a likelihood and an impact of the risk category; and
setting a risk assessment schedule of the assessment subject based upon the level of importance of the assessment subject.

16. The computer program product of claim 15, wherein the computer program product further sets, based upon one or more other profiling questionnaires, the level of importance of and the risk tolerance for the assessment subject of the supply chain.

17. The computer program product of claim 15, wherein the risk assessment schedule of the assessment subject comprises a risk assessment schedule for each risk category of the one or more risk categories for the assessment subject.

18. The computer program product of claim 17, wherein the risk assessment schedule for each risk category of the one or more risk categories for the assessment subject comprises a number of risk assessments over a set period of time, the number of risk assessments for each risk category dependent upon the likelihood and impact of the risk category.

19. The computer program product of claim 18, wherein the computer program further aggregates a most recently completed risk assessment for each risk category of the one or more risk categories for the assessment subject to form a composite risk rating of the assessment subject.

20. The computer program product of claim 15, wherein the computer program further:
sets a level of importance of and a risk tolerance for an assessment bundle, the assessment bundle comprising a plurality of risk categories of the one or more risk categories for the assessment subject; and
wherein the risk assessment schedule of the assessment subject comprises a risk assessment schedule of the assessment bundle based upon the level of importance of the assessment bundle.
